(19) United States
(12) Patent Application Publication
(10) Pub. No.: US 2022/0338445 A1
(43) Pub. Date: Oct. 27, 2022

(54) Toy for accompanying pets

(71) Applicant: Haonan LI, Guangdong (CN)

(72) Inventor: Haonan LI, Guangdong (CN)

(21) Appl. No.: 17/314,059

(22) Filed: May 7, 2021

(30) Foreign Application Priority Data
Apr. 22, 2021 (CN) 202120828121.0

(51) Int. Cl. A01K 15/02

(52) U.S. Cl. CPC A01K 15/025

(57) ABSTRACT

A toy for accompanying pets, containing a toy body and a heartbeat simulation device inside the toy body; the heartbeat simulation device has a shell; a motor is provided inside the shell; the motor is connected to a biased-center rotatable hammer; the motor drives the biased-center rotatable hammer to rotate. When the motor is turned on, the motor rotates and drives the biased-center rotatable hammer to rotate. When the biased-center rotatable hammer rotates, it vibrates and emits buzzing or humming sounds to simulate heartbeats of a living animal.

### BACKGROUND OF THE INVENTION

The present invention relates to the technical field of pet goods, and more specifically relates to a toy for accompanying pets.

Nowadays, affection for pets supplemental to personal or family lives causes consumers to keep small animals as pets. However, due to busy works, pet keepers cannot spare all the time to accompany their pets. Therefore, their pets may feel lonely and have low mood. In such circumstances, pet toys appear in the market. There are currently various kinds of pet toys in the market, but they either focus only on playing, or only on their outer appearance. Hence, most pet toys are mono-functional and involve only low level technology. As such, these pet toys cannot meet the demand for accompanying and soothing pets. Pet toys lack the empathy for pets, and so pets will quickly lose interest in these toys.

### BRIEF SUMMARY OF THE INVENTION

In view of the aforesaid disadvantages now present in the prior art, the present invention provides a kind of toy for accompanying pets, comprising a toy body and a heartbeat simulation device disposed inside the toy body; the heartbeat simulation device comprises a shell; a motor is provided inside the shell; the motor is connected to a biased-center rotatable hammer; the motor drives the biased-center rotatable hammer to rotate.

Further, the toy body is a fluffy stuffed object; an accommodation bag is provided inside the toy body; the accommodation bag has an opening exposed from the toy body; the opening of the accommodation bag is configured with a sealing device that is capable of sealing the accommodation bag; the heartbeat simulation device is placed inside the accommodation bag; after the heartbeat simulation device is placed inside the accommodation bag, the accommodation bag is sealed via the sealing device.

Further, the sealing device is a hook and loop fastener.

Further, a heating device is mounted on the shell.

Further, the motor and the heating device are electrically connected to a circuit control board; the circuit control board is disposed inside the shell; the circuit control board is powered by a battery.

Further, the circuit control board is connected with a temperature sensor; the temperature sensor detects a heating temperature of the heating device, and transfers the detected temperature to the circuit control board; the circuit control board controls operation of the hearing device based on the detected temperature.

Further, the fluffy stuffed object comprises furry surface material and chemical fiber cotton; the chemical fiber cotton is stuffed inside the furry surface material.

Further, the toy body is shaped as a dog or a cat.

Further, the shell comprises a first shell and a second shell; the first shell and the second shell are removably connected.

Further, the first shell and the second shell are removably connected through buckling.

The present invention has the following beneficial effects: the toy for accompanying pets according to the present invention is internally provided with a heartbeat simulation device. When the motor is turned on, the motor rotates and drives the biased-center rotatable hammer to rotate. When the biased-center rotatable hammer rotates, it vibrates and emits buzzing or humming sounds to simulate heartbeats of a living animal to arouse pets' empathy for the toy, thereby adding value to the toy by strengthening the accompanying and soothing effects of the toy on the pets.

### BRIEF DESCRIPTION OF THE DRAWINGS

FIG. 1 is a schematic structural view of a toy for accompanying pet according to an embodiment of the present invention.

FIG. 2 is a schematic structural view of the heartbeat simulation device according to an embodiment of the present invention.

### DETAILED DESCRIPTION OF THE INVENTION

The present invention is further described below in detail with reference to an embodiment. The described embodiment is only intended as one of the many possible embodiments of the present invention. The described embodiment is only intended to illustrate the present invention and should not limit the present invention in any sense.

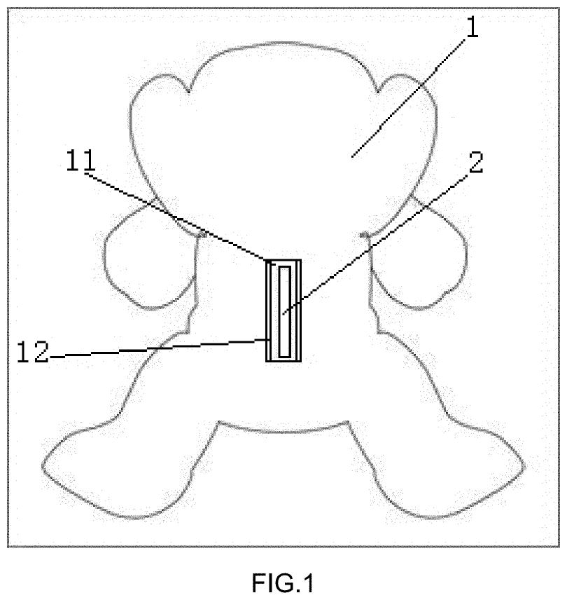

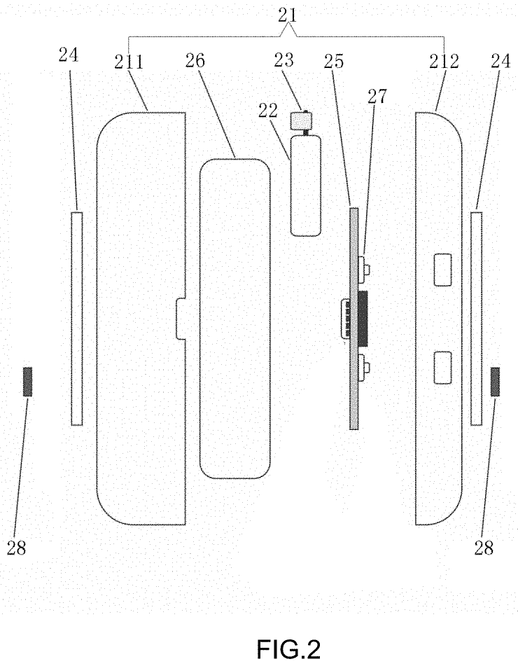

As shown in FIG. 1 and FIG. 2, a toy for accompanying pets, comprising a toy body 1 and a heartbeat simulation device 2 disposed inside the toy body 1. The heartbeat simulation device 2 comprises a shell 21; a motor 22 is provided inside the shell 12; the motor 22 is connected to a biased-center rotatable hammer 23; the motor drives the biased-center rotatable hammer 23 to rotate.

According to the toy for accompanying pets of the present invention, the heartbeat simulation device 2 is internally disposed inside the toy. When the motor 22 is turned on, the motor 22 rotates and drives the biased-center rotatable hammer 23 to rotate. When the biased-center rotatable hammer 23 rotates, it vibrates and emits buzzing or humming sounds to simulate heartbeats of a living animal to arouse pets' empathy for the toy, thereby adding value to the toy by strengthening the accompanying and soothing effects of the toy on the pets.

Further, the toy body 1 is a fluffy stuffed object. An accommodation bag 11 is provided inside the toy body 1; the accommodation bag 11 has an opening exposed from the toy body 1; the opening of the accommodation bag 11 is configured with a sealing device 12 that is capable of sealing the accommodation bag 11. The heartbeat simulation device 2 is placed inside the accommodation bag 11. After the heartbeat simulation device 2 is placed inside the accommodation bag 11, the accommodation bag 11 is sealed via the sealing device 12. By using the above configurations, the heartbeat simulation device 2 can be removably mounted in the toy body 1. In case of component failure in the heartbeat simulation device 2, the heartbeat simulation device 2 can be taken out for repair or replacement.

Further, the sealing device 12 is a hook and loop fastener. Of course, other structures, for example a zipper, may be possible apart from using a hook and loop fastener.

Further, a heating device 24 is mounted on the shell 21; the heating device 24 is attached to an outer surface of the shell 21 to simulate body temperature of a living animal.

Further, the motor 22 and the heating device 24 are electrically connected to a circuit control board 25; the circuit control board 25 is disposed inside the shell 21; the circuit control board 25 is powered by a battery 26.

Further, a switch 27 is connected to the circuit control board 25; the switch 27 controls operating modes of the circuit control board 25.

Further, the circuit control board 25 is connected with a temperature sensor 28; the temperature sensor 28 detects a heating temperature of the heating device 24, and transfers the detected temperature to the circuit control board 25; the circuit control board 25 controls operation of the hearing device 24 based on the detected temperature.

Further, the toy body 1 is a fluffy stuffed object; the fluffy stuffed object comprises furry surface material and chemical fiber cotton; the chemical fiber cotton is stuffed inside the furry surface material. The use of chemical fiber cotton produces a soft texture and is good at maintaining temperature. Therefore, pets feel great comfort when playing with the toy.

Further, the toy body 1 is shaped as a dog or a cat.

Further, the shell 21 comprises a first shell 211 and a second shell 212; the first shell 211 and the second shell 212 are removably connected which may be achieved in many ways such as through buckling.

The above description only describes a preferred embodiment of the present invention, and is not intended to impose any limitation to the form of the present invention. Although the present invention is disclosed via a preferred embodiment as described above, the described embodiment is not intended to limit the present invention. Some changes or modifications based on the above disclosure can be made by a person skilled in this field of art to obtain an alternative embodiment achieving the same technical effect without deviating from the scope of the present invention. Any simple changes, modifications or alternative configurations achieving the same technical effect of the above embodiment based on the essence of the technical solutions provided by the present invention without deviating from the disclosure of the present invention should fall within the scope of the present invention.

What is claimed is:

1. A toy for accompanying pets, comprising a toy body and a heartbeat simulation device disposed inside the toy body; the heartbeat simulation device comprises a shell; a motor is provided inside the shell; the motor is connected to a biased-center rotatable hammer; the motor drives the biased-center rotatable hammer to rotate.

2. The toy for accompanying pets of claim 1, wherein the toy body is a fluffy stuffed object; an accommodation bag is provided inside the toy body; the accommodation bag has an opening exposed from the toy body; the opening of the accommodation bag is configured with a sealing device that is capable of sealing the accommodation bag; the heartbeat simulation device is placed inside the accommodation bag; after the heartbeat simulation device is placed inside the accommodation bag, the accommodation bag is sealed via the sealing device.

3. The toy for accompanying pets of claim 2, wherein the sealing device is a hook and loop fastener.

4. The toy for accompanying pets of claim 1, wherein a heating device is mounted on the shell.

5. The toy for accompanying pets of claim 4, wherein the motor and the heating device are electrically connected to a circuit control board; the circuit control board is disposed inside the shell; the circuit control board is powered by a battery.

6. The toy for accompanying pets of claim 5, wherein the circuit control board is connected with a temperature sensor; the temperature sensor detects a heating temperature of the heating device, and transfers the detected temperature to the circuit control board; the circuit control board controls operation of the hearing device based on the detected temperature.

7. The toy for accompanying pets of claim 2, wherein the fluffy stuffed object comprises furry surface material and chemical fiber cotton; the chemical fiber cotton is stuffed inside the furry surface material.

8. The toy for accompanying pets of claim 1, wherein the toy body is shaped as a dog or a cat.

9. The toy for accompanying pets of claim 1, wherein the shell comprises a first shell and a second shell; the first shell and the second shell are removably connected.

10. The toy for accompanying pets of claim 9, wherein the first shell and the second shell are removably connected through buckling.
